(19) United States
(12) Patent Application Publication
(10) Pub. No.: US 2026/0102756 A1
(43) Pub. Date: Apr. 16, 2026

(54) FILTER FOR USE IN A CAP OF LIQUID CONTAINERS

(71) Applicant: Robert Brown, Las Vegas, NV (US)

(72) Inventor: Robert Brown, Las Vegas, NV (US)

(21) Appl. No.: 18/915,393

(22) Filed: Oct. 15, 2024

(51) Int. Cl. B01J 20/20; B01D 15/08; B01J 20/28; B65D 51/24

(52) U.S. Cl. CPC B01J 20/20; B01D 15/08; B01J 20/28033; B65D 51/24

(57) ABSTRACT

A liquid filter for use in a cap of a liquid container is disclosed. The liquid filter comprises a filter body configured to fit within the cap of the liquid container. The filter body having a bottom, a top, and at least one lateral surface. A filtration medium housed within the filter body. The filtration medium absorbs contaminants from liquid. At least one flow rate reduction element positioned at the bottom of the filter body. The flow rate reduction element partially covering the bottom of the filter body to regulate flow of the liquid through the filtration medium. The at least one flow rate reduction element is designed to increase a contact time between the liquid and the filtration medium. At least one outlet flow guiding element positioned at the top of the filter body to guide flow of the liquid through a portion of the filter body.

### TECHNICAL FIELD

This disclosure relates generally to liquid filtration systems and more particularly to a liquid filter for use in a cap of liquid containers.

### BACKGROUND

Liquid filtration is an essential process in a wide range of applications including drinking liquid purification. The primary goal of filtration systems is to remove contaminants, impurities, and undesirable substances from liquids to make them safe and suitable for consumption or use. Over the years, advancements in filtration technology have led to the development of various solutions designed to enhance filtration efficiency and ensure higher liquid quality.

Despite these advancements, many existing filtration systems still face significant challenges. One major issue is the inconsistent regulation of liquid flow through the filter medium. In many cases, when the flow rate is too high, the contact time between the liquid and the filtration medium is reduced, resulting in lower contaminant removal efficiency. On the other hand, an excessively low flow rate can lead to slow processing times and reduced throughput, making the system less practical for everyday use. Another common limitation of conventional filtration solutions is their design compatibility with different types of liquid containers. Many filters are specifically tailored for reusable or fixed-size containers, limiting their applicability to only a select range of products. As consumer demands evolve and the need for portable and versatile filtration solutions increases, there is a growing need for filters that can be easily retrofitted into a variety of container types, including single-use and disposable bottles.

Accordingly, there is a need for a liquid filter for use in a cap of liquid containers, which addresses the limitations of existing filtration systems.

### SUMMARY OF THE INVENTION

In an embodiment, a liquid filter for use in a cap of a liquid container is disclosed. The liquid filter may include a filter body configure to fit within the cap of the liquid container. In an embodiment, the filter body may have a bottom, a top, and at least one lateral surface. The liquid filter may further include a filtration medium housed within the filter body. In an embodiment, the filtration medium absorbs contaminants from liquid. The liquid filter may further include at least one flow rate reduction element positioned at the bottom of the filter body. In an embodiment, the at least one flow rate reduction element may partially cover the bottom of the filter body to regulate flow of the liquid through the filtration medium. In an embodiment, the at least one flow rate reduction element may be designed to increase a contact time between the liquid and the filtration medium. The liquid filter may further include at least one outlet flow guiding element positioned at the top of the filter body. In an embodiment, the at least one outlet flow guiding element partially covering the top of the filter body to guide flow of the liquid through a portion of the filter body, not covered by the at least one outlet flow guiding element.

In another embodiment, the at least one lateral surface and a portion of the bottom of the filter body, not covered by the at least one flow rate reduction element, may from an inlet for the liquid to enter the filtration medium.

In another embodiment, the at least one flow rate reduction element may include a solid structure positioned at the bottom of the filter body to maintain a controlled flow rate of the liquid through the filtration medium.

In another embodiment, the at least one outlet flow guiding element may include a solid structure positioned at the top of the filter body to guide flow of the liquid through the portion of the filter body, not covered by the at least one outlet flow guiding element.

In another embodiment, the filtration medium may include granular activated carbon (GAC) for absorbing the contaminants from the liquid.

In yet another embodiment, the filter body may include a water permeable membrane.

It is to be understood that both the foregoing general description and the following detailed descriptions are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1A illustrates a front view of an exemplary liquid filter, in accordance with an embodiment of the present disclosure.

FIG. 1B illustrates a flow of liquid through the liquid filter depicted in FIG. 1A, in accordance with an embodiment of the present disclosure.

FIG. 1C illustrates a top view of the liquid filter depicted in FIG. 1A, in accordance with an embodiment of the present disclosure.

FIG. 2A illustrates a front view of another exemplary liquid filter, in accordance with an embodiment of the present disclosure.

FIG. 2B illustrates a flow of liquid through the liquid filter depicted in FIG. 2A, in accordance with an embodiment of the present disclosure.

FIG. 2C illustrates a top view of the liquid filter depicted in FIG. 2A, in accordance with an embodiment of the present disclosure.

FIG. 3A illustrates a front view of another exemplary liquid filter, in accordance with an embodiment of the present disclosure.

FIG. 3B illustrates a flow of liquid through the liquid filter depicted in FIG. 3A, in accordance with an embodiment of the present disclosure.

FIG. 3C illustrates a top view of the liquid filter depicted in FIG. 3A, in accordance with an embodiment of the present disclosure.

FIG. 4 illustrates a deployment scenario in which the liquid filter depicted in FIG. 1A, FIG. 2A, and FIG. 3A can be integrated into a cap of a liquid container, in accordance with an exemplary embodiment of the present disclosure.

### DETAILED DESCRIPTION OF THE DRAWINGS

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for conducting the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusion, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

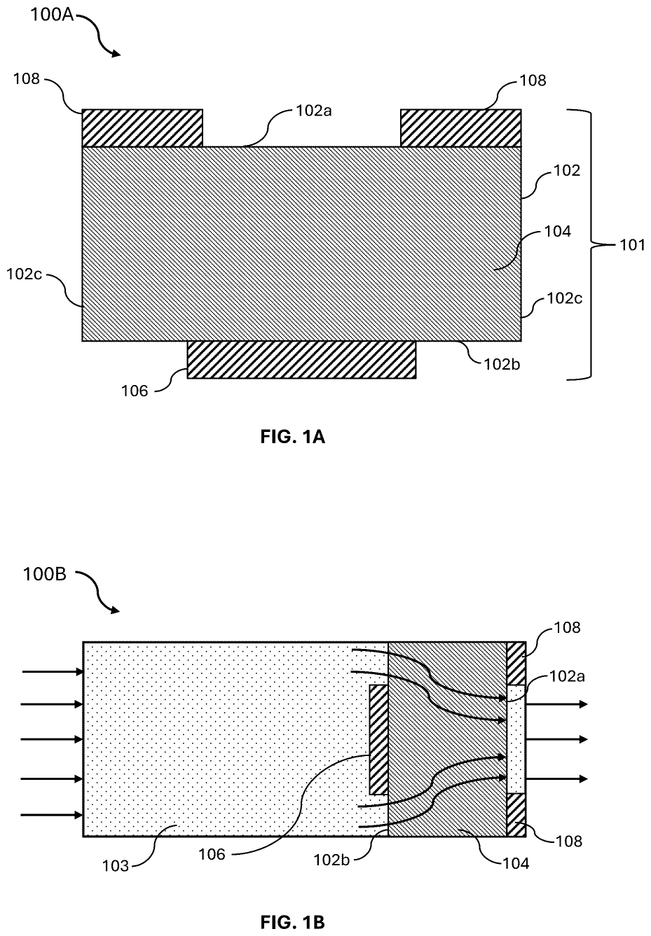

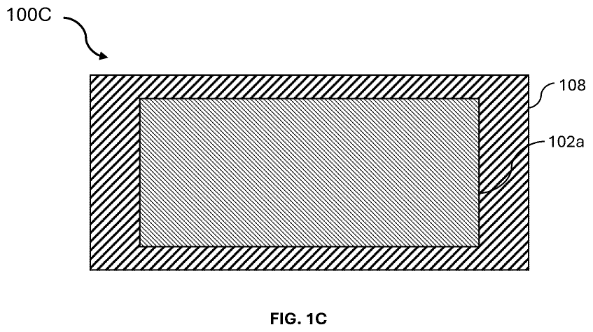

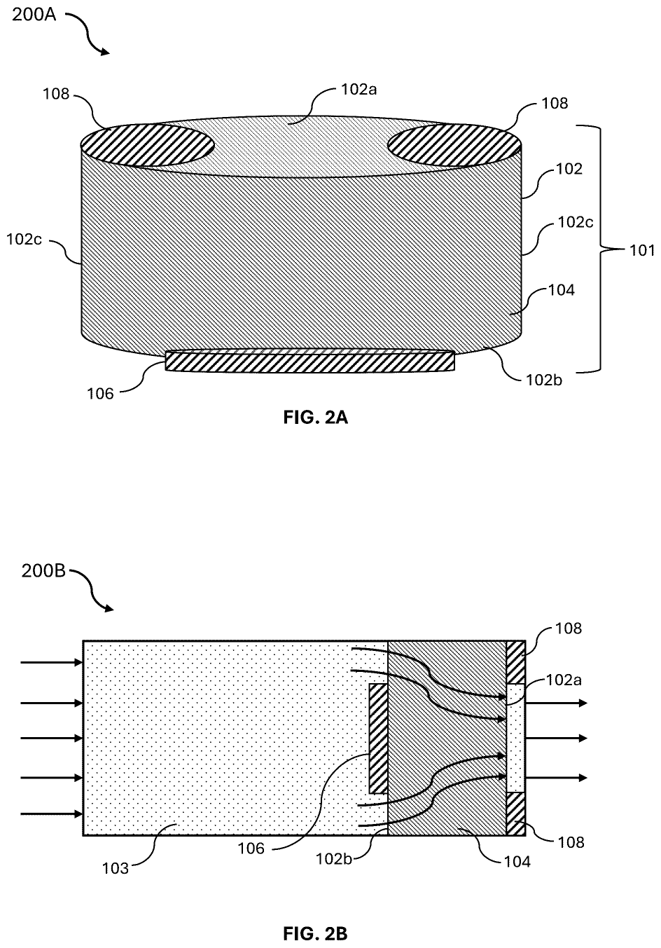

Reference will now be made to the exemplary embodiments of the disclosure, as illustrated in the accompanying drawings. Wherever possible, same numerals have been used to refer to the same or like parts. The following paragraphs describe the present disclosure with reference to FIG. 1A-FIG. 4. As summarized above, in one broad aspect, the present invention provides a liquid filter for use in a cap of liquid containers.

Referring now to FIG. 1A, a front view 100A of an exemplary liquid filter 101 is illustrated, in accordance with an embodiment of the present disclosure. The liquid filter 101 is shown in FIG. 1A as being of a generally rectangular shape, although other shapes such as cylindrical, conical, or polygonal may be used without departing from the scope of the invention.

The liquid filter 101 may include a filter body 102 configured to fit within a cap (not shown in this figure) of a liquid container (not shown in this figure). The filter body 102 may have a top 102a, a bottom 102b and at least one lateral surface 102c. The top 102a of the filter body 102 may be positioned adjacent to the cap of the liquid container, while the bottom 102b is located closer to the main body of the liquid container itself. The liquid filter 101 may further include a filtration medium 104 housed within the filter body 102. The filtration medium 104 is designed to absorb contaminants from liquid that pass through it. In one embodiment, the filtration medium 104 may include granular activated carbon (GAC), although other filtration media such as activated alumina, ceramic, or ion-exchange resin can also be utilized depending on the specific application requirements. The choice of the filtration medium 104 can be tailored to address particular contaminants found in different types of liquids, such as water, beverages, or other consumables.

The liquid filter 101 may further include at least one flow rate reduction element 106 positioned at the bottom 102b of the filter body 102. The at least one flow rate reduction element 106 may partially cover the bottom 102b of the filter body 102 to regulate flow of the liquid through the filtration medium 104. By partially restricting the flow, the flow rate reduction element 106 increases the contact time between the liquid and the filtration medium 104, thereby enhancing the efficiency of contaminant removal. The flow rate reduction element 106 may be a solid structure that serves to maintain a controlled flow rate, preventing the liquid from passing too quickly through the filter and ensuring that optimal filtration performance is achieved.

In addition to the flow rate reduction element 106, the liquid filter 101 may also include at least one outlet flow guiding element 108 positioned at the top 102a of the filter body 102. The at least one outlet flow guiding element 108 partially covers the top 102a of the filter body 102 to guide flow of the liquid through a portion of the filter body 102, not covered by the at least one outlet flow guiding element 108. The outlet flow guiding element 108 functions to direct the flow of filtered liquid out of the filter body 102, ensuring that the liquid flows uniformly through the filtration medium 104 before exiting. The outlet flow guiding element 108 may also help in maintaining the structural integrity of the filter body 102, particularly when it is subjected to pressure changes during the filtering process.

The at least one lateral surface 102c and a portion of the bottom 102b of the filter body 102 that is not covered by the flow rate reduction element 106 may serve as an inlet for the liquid to enter the filtration medium 104. This inlet design allows for a smooth entry of the liquid into the filtration medium 104, facilitating uniform distribution and preventing channelling effects that can reduce the effectiveness of the filtration process.

In an alternative embodiment, the filter body 102 itself may be constructed from a water-permeable membrane, thereby allowing liquid to pass through its walls in addition to the designated inlet. This configuration could enhance the overall filtration capacity of the liquid filter 101 by increasing the surface area available for liquid to interact with the filtration medium 104.

The design of the flow rate reduction element 106 and the outlet flow guiding element 108 can vary depending on the specific requirements of the liquid filter 101. For instance, in some embodiments, the flow rate reduction element 106 may offer resistance to liquid flow. The combination of these elements within the liquid filter 101 allows for a highly adaptable filtering solution that can be tailored to different liquid container caps and various filtration requirements. This adaptability ensures that the liquid filter 101 can be used effectively across a wide range of single-use and reusable containers, thereby overcoming the limitations of conventional filtration systems that are restricted to specific bottle designs.

In an alternate embodiment, the liquid filter 101 may be designed without a traditional filter body 102, instead relying solely on a filtration medium 104 composed of granular materials. This embodiment allows the filtration medium 104 to be utilized directly in the cap of a liquid container, enhancing simplicity and minimizing material usage. The filtration medium 104, such as granular activated carbon (GAC), is strategically arranged to create a self-supporting structure that permits liquid to flow through while effectively capturing contaminants. This configuration enables the granular medium to directly interact with the liquid, maximizing contact surface area and enhancing adsorption efficiency for contaminants such as chlorine, sediment, and other impurities commonly found in drinking water.

To optimize performance, the filtration medium 104 may be housed within a mesh or net-like structure, which maintains the integrity of the granules while allowing for unrestricted fluid movement. The absence of a defined filter body facilitates a flexible design that can easily conform to various cap shapes and sizes, such as cylindrical, conical, or polygonal forms. Furthermore, this embodiment may incorporate flow rate reduction elements and outlet flow guiding elements directly integrated into the structure of the granular medium itself, ensuring that liquid is evenly distributed across the filtration surface. In scenarios where specific contaminants need to be addressed, the choice of the granular medium can be tailored based on its properties, such as particle size, porosity, and adsorption capabilities.

FIG. 1B, a flow of liquid 103 through the liquid filter 101 depicted in FIG. 1A is illustrated, in accordance with an embodiment of the present disclosure. The figure effectively demonstrates the enhanced efficiency of liquid absorption facilitated by the incorporation of the at least one flow rate reduction element 106 and the at least one outlet flow guiding element 108.

As the liquid 103 enters the filter 101 through the at least one lateral surface 108 and the bottom 102b inlet (as described in greater detail in FIG. 1A), the liquid 103 encounters the flow rate reduction element 106 positioned at the bottom 102b of the filter body 102. The flow rate reduction element 106 serves a crucial role in regulating the flow velocity of the liquid 103, causing the liquid 103 to spread more evenly across the filtration medium 104. By partially obstructing the flow, the flow rate reduction element 106 increases the contact time between the liquid 103 and the filtration medium 104, thereby significantly enhancing the absorption of contaminants present in the liquid 103.

In experimental studies, such as those conducted using computational fluid dynamics (CFD) simulations, the effects of varying flow rates on the adsorption efficiency of activated carbon filters have been rigorously analyzed. For instance, results from the CFD simulation report highlight the importance of controlling flow velocity in enhancing the adsorption performance of granular activated carbon (GAC) filters. The increased contact time resulting from a regulated flow facilitates a higher rate of contaminant removal, particularly for substances like chloroform, which is commonly found in drinking water as a byproduct of chlorine disinfection.

The efficacy of the liquid filter 101 is further improved by the at least one outlet flow guiding element 108 positioned at the top 102a of the filter body 102. The at least one outlet flow guiding element 108 optimizes the path of the liquid 103 as it exits the filtration medium 104, thereby ensuring that the flow is directed uniformly across the outlet. The guiding structure minimizes turbulence and uneven flow, which can lead to decreased filtration efficiency. By effectively channelling the liquid 103, the at least one outlet flow guiding element 108 ensures that the filtered liquid is uniformly treated before exiting, thus maximizing the removal of contaminants from the liquid 103. The detailed design of the filter 101, including the placement and structure of the flow rate reduction element 106 and the outlet flow guiding element 108, is essential in achieving optimal performance. As shown in FIG. 1B, the interaction between these elements and the filtration medium can significantly affect the overall adsorption rate and the efficacy of the liquid filter.

Referring now to FIG. 1C, a top view 100C of the liquid filter 101 depicted in FIG. 1A, is illustrated, in accordance with an embodiment of the present disclosure. FIG. 1C provides a clear representation of the liquid filter 101, highlighting its rectangular shape, which is defined by a perimeter formed by the filter body 102. The filter body 102 is depicted with the top 102a of the filter body, indicating the position where the filter would connect to a cap (not shown in this figure) of a liquid container (not shown in this figure). Surrounding the filter body 102 is the at least one outlet flow guiding element 108.

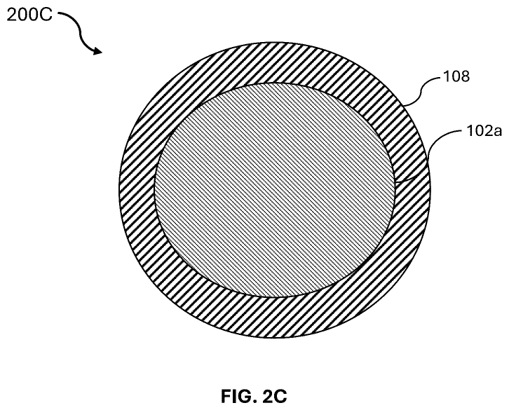

Referring now to FIG. 2A, a front view 200A of another exemplary liquid filter 101 is illustrated, in accordance with an embodiment of the present disclosure. This embodiment of the liquid filter 101 is characterized by a cylindrical shape. FIG. 2A exemplifies a cylindrical liquid filter design that maintains the essential functionalities of the previously described rectangular liquid filter as explained in FIG. 1A.

Referring now to FIG. 2B, a flow of liquid 103 through the liquid filter 101 depicted in FIG. 2A, is illustrated, in accordance with an embodiment of the present disclosure. As depicted in FIG. 1B, in this embodiment, the liquid 103 flows into the filter body 102 through the inlet formed by the lateral surface 102c and the bottom surface 102b, where the liquid 103 encounters the at least one flow rate reduction element 106 positioned at the bottom 102b. The at least one flow rate reduction element 106 regulates the liquid's passage, enhancing contact time between the liquid 103 and the filtration medium 104, which is crucial for maximizing the absorption of contaminants. As the liquid 103 continues its flow upwards through the filter body, the liquid 103 is guided by the at least one outlet flow guiding element 108 situated at the top surface 102a, ensuring an efficient and directed exit from the liquid filter 101.

Referring now to FIG. 2C, a top view 200C of the liquid filter 101 depicted in FIG. 2A, in accordance with an embodiment of the present disclosure. The figure presents a circular cross-section of the cylindrical liquid filter 101, showcasing the filter body 102 and the top surface 102a. At the centre of the liquid filter 101 is the filtration medium 104, surrounded by the at least one outlet flow guiding element 108, which is positioned at the top 102a of the filter body 102.

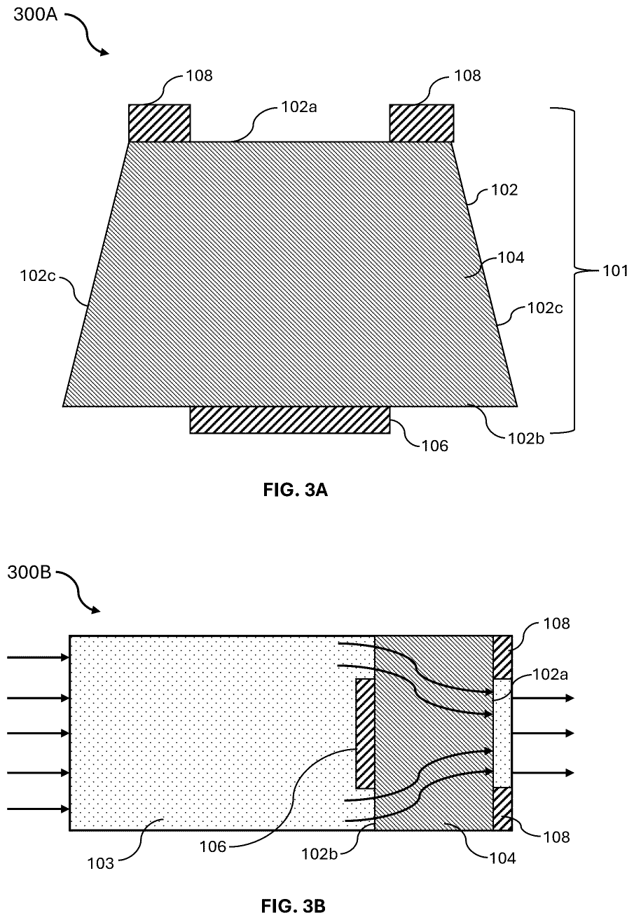

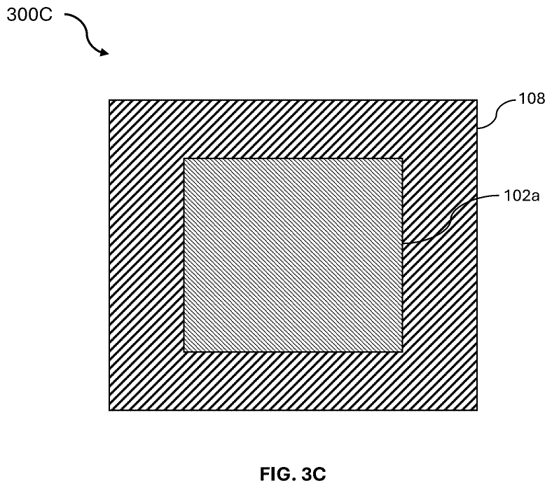

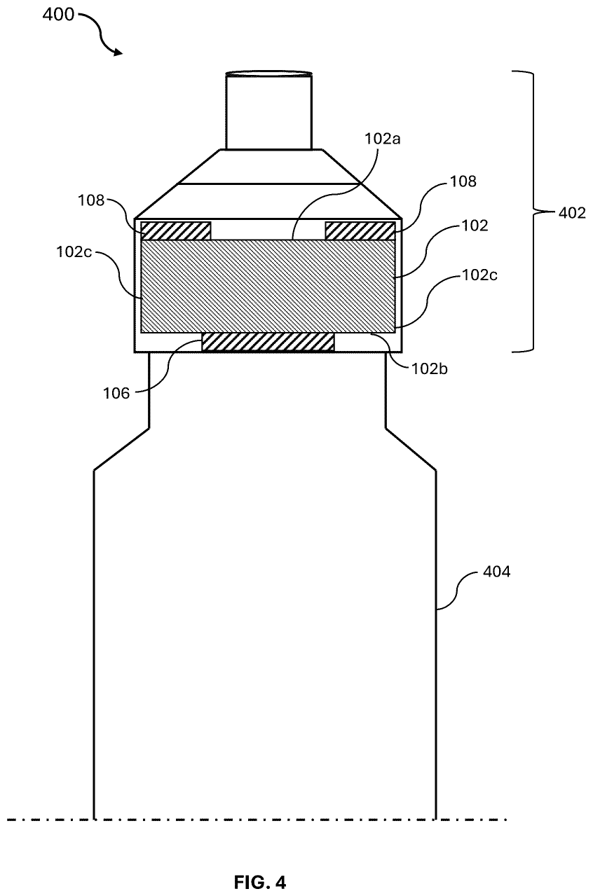

Referring now to FIG. 3A, a front view 300A of another exemplary liquid filter 101 is illustrated, in accordance with an embodiment of the present disclosure. This embodiment of the liquid filter 101 is characterized by a trapezoidal shape. FIG. 3A exemplifies a trapezoidal liquid filter design that maintains the essential functionalities of the previously described rectangular liquid filter as explained in FIG. 1A.

Referring now to FIG. 3B, a flow of liquid through the liquid filter 101 depicted in FIG. 3A, is illustrated, in accordance with an embodiment of the present disclosure. As depicted in FIG. 1B, in this embodiment, the liquid 103 flows into the filter body 102 through the inlet formed by the lateral surface 102c and the bottom surface 102b, where the liquid 103 encounters the at least one flow rate reduction element 106 positioned at the bottom 102b. The at least one flow rate reduction element 106 regulates the liquid's passage, enhancing contact time between the liquid 103 and the filtration medium 104, which is crucial for maximizing the absorption of contaminants. As the liquid 103 continues its flow upwards through the filter body, the liquid 103 is guided by the at least one outlet flow guiding element 108 situated at the top surface 102a, ensuring an efficient and directed exit from the liquid filter 101.

Referring now to FIG. 3C, a top view 300C of the liquid filter 101 depicted in FIG. 3A, in accordance with an embodiment of the present disclosure. The figure presents a square cross-section of the trapezoidal liquid filter 101, showcasing the filter body 102 and the top surface 102a. At the centre of the liquid filter 101 is the filtration medium 104, surrounded by the at least one outlet flow guiding element 108, which is positioned at the top 102a of the filter body 102.

Referring now to FIG. 4, a deployment scenario 400 in which the liquid filter 101 depicted in FIG. 1A, FIG. 2A, and FIG. 3A can be integrated into a cap 402 of a liquid container 404, in accordance with an exemplary embodiment of the present disclosure. In this configuration, the liquid filter 101 is positioned within the interior of the cap 402, allowing the liquid filter 101 to efficiently filter liquid as the liquid flows from the container 404 through the cap 402.

In one embodiment, the liquid filter 101, as shown in previous figures, can be utilized in single-use plastic bottles, enabling users to remove harmful contaminants from beverages on-the-go. For instance, the integration of the filter into a cap of a bottled water container ensures that the water is filtered immediately before consumption, addressing concerns over contaminants such as nano plastics and Obesogens present in bottled beverages.

Moreover, the liquid filter 101 can also be adapted for use in larger containers, such as jugs or dispensers, where a larger cap design can accommodate an expanded filtration medium for improved absorption efficiency. In such scenarios, the liquid filter 101 may be equipped with multiple flow rate reduction elements 106 to enhance liquid contact time with the filtration medium 104, thereby optimizing contaminant removal. In another embodiment, the liquid filter 101 can be designed to fit into reusable caps for sports bottles or travel mugs, promoting sustainability while ensuring that users have access to clean, purified liquids. The versatility of the liquid filter 101 makes it suitable for a range of applications, from personal hydration solutions to larger-scale water filtration systems.

Thus, the disclosed liquid filter 101 tries to overcome the technical problem of insufficient contaminant removal and inadequate filtration efficiency in conventional liquid filtration systems. Traditional filters often fail to provide optimal flow rates and contact times between the liquid and the filtration medium, leading to subpar absorption of harmful substances, such as chemicals and impurities, present in drinking water. By incorporating innovative elements such as the flow rate reduction element 106 and the outlet flow guiding element 108, the liquid filter 101 enhances the interaction between the liquid and the filtration medium 104, ensuring a more thorough and effective purification process. This advancement not only improves the overall performance of the liquid filter 101 but also addresses health and safety concerns associated with contaminated liquid, ultimately promoting better public health outcomes.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to” and indicate that the components listed are included, but not generally to the exclusion of other components. Such terms encompass the terms “consisting of”and “consisting essentially of”.

As used herein, the singular form “a”, “an” and “the” may include plural references unless the context clearly dictates otherwise. For example, the term “a compound” or “at least one compound”may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional”features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

What is claimed is:

1. A liquid filter for use in a cap of a liquid container, the liquid filter comprising:
a filter body configured to fit within the cap of the liquid container, wherein the filter body having a bottom, a top, and at least one lateral surface;
a filtration medium housed within the filter body, wherein the filtration medium absorbs contaminants from liquid;
at least one flow rate reduction element positioned at the bottom of the filter body,
wherein the at least one flow rate reduction element partially covering the bottom of the filter body to regulate flow of the liquid through the filtration medium, and
wherein the at least one flow rate reduction element is designed to increase a contact time between the liquid and the filtration medium; and
at least one outlet flow guiding element positioned at the top of the filter body,
wherein the at least one outlet flow guiding element partially covering the top of the filter body to guide flow of the liquid through a portion of the filter body, not covered by the at least one outlet flow guiding element.

2. The liquid filter of claim 1, wherein the at least one lateral surface and a portion of the bottom of the filter body, not covered by the at least one flow rate reduction element, form an inlet for the liquid to enter the filtration medium.

3. The liquid filter of claim 1, wherein the at least one flow rate reduction element comprises a solid structure positioned at the bottom of the filter body to maintain a controlled flow rate of the liquid through the filtration medium.

4. The liquid filter of claim 1, wherein the at least one outlet flow guiding element comprises a solid structure positioned at the top of the filter body to guide flow of the liquid through the portion of the filter body, not covered by the at least one outlet flow guiding element.

5. The liquid filter of claim 1, wherein the filtration medium comprises granular activated carbon (GAC) for absorbing the contaminants from the liquid.

6. The liquid filter of claim 1, wherein the filter body comprises a water permeable membrane.
